(19) United States
(12) Patent Application Publication
(10) Pub. No.: US 2013/0064899 A1
(43) Pub. Date: Mar. 14, 2013

(54) SYNERGISTIC BIOCIDE COMPOSITION CONTAINING AT LEAST THREE BIOCIDE COMPONENTS

(71) Applicants: Hans-Jürgen Schmidt, Speyer (DE); Rüdiger Baum, Waghausel (DE); Thomas Wunder, Neustadt (DE)

(72) Inventors: Hans-Jürgen Schmidt, Speyer (DE); Rüdiger Baum, Waghausel (DE); Thomas Wunder, Neustadt (DE)

(73) Assignee: THOR GMBH, Speyer (DE)

(21) Appl. No.: 13/699,660

(22) PCT Filed: May 23, 2011
(86) PCT No.: PCT/EP2011/002568

§ 371 Date: Nov. 23, 2012

(30) Foreign Application Priority Data
May 26, 2010 (EP) 10005440.2

(51) Int. Cl. A01N 59/16; A01N 55/02

(52) U.S. Cl. CPC A01N 59/16
USPC 424/618

(57) ABSTRACT

The invention relates to a biocide composition which contains (A) silver, (B) one or more pyrithione(s) and (C) one or more 1,2-benzisothiazolin-3-one derivative(s) as microbiocidal active components.

The invention relates to a biocide composition which comprises a combination of at least three active biocidal components. The first component is a silver component, the second is at least one pyrithione component, and the third is at least one 1,2-benzisothiazolin-3-one component. The biocide composition of the invention is suitable particularly for controlling microorganisms.

Biocidal products are used in numerous areas of everyday life, as for example for the control of bacteria, fungi, or algae. It has long been known that compounds from the class of the 3-isothiazolin-3-ones, also referred to as 3-isothioazolones, can be used in such compositions.

This class of compound includes very effective biocide compounds with in some cases different activity profiles. Use is often also made of combinations of different 3-isothiazolin-3-ones, or else of one or more 3-isothiazolin-3-ones with other biocidal actives (compare, inter alia, WO 99/08530 A1, EP 0 457 435 A1, EP 0 542 721 A1 and WO 02/17716 A1).

In light of the continually growing requirements imposed on such biocide compositions, with respect, for example, to considerations of health and environmental protection, the further development of the known products is necessary.

Silver and its compounds have an antimicrobial activity. Examples of silver products described for preservation use include elemental silver in colloidal form, dispersions of nanoparticulate silver, silver compounds, such as silver oxide, or organic and inorganic silver salts. The silver or the silver compounds in these products may also be imbedded in carrier materials, such as silicas, titanium oxide, zeolites, or glass, for example.

One of the drawbacks of silver-mediated preservation is that silver compounds, especially in the presence of reducing compounds and under the influence of light, can lead to instances of discoloration. Furthermore, the activity of silver with respect to yeasts and molds is not as pronounced as it is with respect to bacteria, hence necessitating higher use concentrations for a balanced spectrum of activity—and in turn entailing an increased incidence of discolorations. Moreover, as compared with many other biocidal formulations on the market, silver-containing biocide products are also fairly expensive, which significantly limits their use economically.

Examples of common fields of use of silver as an antimicrobial agent encompass the sectors of medicine and of pharmacy, and also of water treatment. In the sector of industrial preservation, as in the case of adhesives, sealants, and coating materials, such as paints, renders, and varnishes, for bath and WC articles, and also in the case of polymer dispersions, pigment preparations, and plastics, for example, silver is identified as a possible biocide in DE 10 346 387 A1. Although silver has indeed found an application in the antimicrobial treatment of surfaces, it has not so far become established for the storage preservation of water-based liquid products.

A further class of biocide compounds are the so-called pyrithiones. Pyrithiones are known biocidal adjuvants, which can be used in a multiplicity of applications. Sodium pyrithione (also called the sodium salt of 1-hydroxy-2-pyridinethione) is a pyrithione salt that has outstanding biocidal properties. Zinc pyrithione (also called the zinc salt of 1-hydroxy-2-pyridinethione) is likewise an outstanding biocide and can be prepared, for example, by reaction of 1-hydroxy-2-pyridinethione with a zinc salt such as ZnSO₄.

It is common knowledge that heavy metal compounds in conjunction with pyrithiones can lead to instances of discoloration. In the presence of iron(III) ions, for example, compositions containing sodium pyrithione and zinc pyrithione have a tendency toward a blue discoloration, even if the iron(III) ion is present only in traces. Similarly, under the influence of UV light, photodegeneration of the pyrithione may occur, leading to a yellow discoloration. This blue or yellow discoloration is undesirable on both esthetic and functional grounds. One way of eliminating these problems is disclosed in U.S. Pat. No. 4,161,526 to Sterling Drug Inc., which specifies the use of zinc oxide for the purpose of preventing discoloration.

It is therefore an object of the invention to specify a biocide composition having at least three different active biocidal components and distinguished by the synergistic interaction of its components, which can therefore be used in lower concentrations when employed simultaneously, as compared with the necessary concentrations in the case of the respective individual components. In this way, humankind and the environment are to be burdened to a lesser extent, and the costs of controlling harmful/unwanted microorganisms are to be lowered.

This object is achieved by means of a biocide composition comprising as active microbiocidal components
(A) silver,
(B) one or more pyrithiones, and
(C) one or more 1,2-benzisothiazolin-3-one derivatives.

The biocide composition of the invention is distinguished by the synergistic interaction of the at least three active biocidal components—of the at least one pyrithione with the at least one 1,2-benzisothiazoline derivative and with the silver—which makes it possible to lower the required use concentrations of the pyrithione and/or of the 1,2-benzisothiazolin-3-one derivative and/or of the silver. In this way it is possible advantageously, in numerous fields of application, to lower the sensitizing effect of biocide compositions comprising benzisothiazolin-3-ones, and to improve their environmental compatibility. At the same time it is possible to lower the costs significantly as compared with known biocide preparations containing silver.

A further advantage of the biocide compositions of the invention, in addition to their broad activity spectrum, lies in their long-term stability and long-term activity. The biocide compositions of the invention and also the preparations and products rendered antimicrobial using said compositions are stable on storage and are less sensitive to light than the known silver-containing and/or pyrithione-containing compositions and products. The preparation can easily be formulated so that there are no instances, or at least no notable instances, of discoloration or graying of the products rendered biocidal in accordance with the invention, when they are properly employed. Thus, the biocide composition of the invention is suitable especially for the biocidal treatment of products for which it is desired that there be no discoloration or graying in practical use, such as for paints, adhesives, dispersions, surface coatings, latices, varnishes, and the like, for example.

A further advantage of the biocide compositions of the invention is that they have low emissions, especially in comparison to biocide compositions based on 3-isothioazolin-3-ones, this being particularly advisable for use in the interior sector. For this reason as well they are especially suitable for the preservation of paints, varnishes, adhesives, and the like. A further feature of the biocide composition of the invention is that its active biocidal components are active over a long time period in practical use. The composition is therefore suitable preferably for long-term preservation.

The biocide composition of the invention is designed, moreover, so that it can be formulated entirely without the presence of halogenated 3-isothiazolin-3-ones, more particularly with complete absence of 5-chloro-2-methyliso-thiazolin-3-one (0% by weight), and such that, furthermore, the AOX values are significantly below those prescribed by statute. The toxicological and ecotoxicological characteristics of the biocide composition of the invention as well, therefore, are significantly improved.

The pyrithiones and 1,2-benzisothiazolinones used in accordance with the invention are known compounds and as such are available commercially or can be prepared by known methods.

1,2-Benzisothiazolin-3-one derivatives that are contemplated include 1,2-benzisothiazolin-3-one and also many compounds of this kind - more particularly, for the biocide composition of the invention, the known, biocidally active N-alkyl-1,2-benzisothiazolin-3-ones having 0 to 8-atoms in the alkyl radical, such as N-methyl-1,2-benzisothiazolin-3-one (also called M-BIT below) or N-butyl-1,2-benzisothiazolin-3-one (also called B-BIT below), and 1,2-benzisothiazolin-3-one (also called BIT below). It is possible, furthermore, to use 2,2′-dithiobis(N-alkylbenzamides). Under weakly alkaline conditions, these compounds release the corresponding N-alkylbenzisothiazolones. The biocide composition of the invention may comprise only one or else a mixture of two, three or more of the 1,2-benzisothiazolin-3-one derivatives. The biocide composition is therefore characterized in that the 1,2-benzisothiazolin-3-one derivative is 1,2-benzisothiazolin-3-one, N-methyl-1,2-benzisothiazolin-3-one, or N-butyl-1,2-benzisothiazolin-3-one, or a mixture of at least two of these compounds. The 1,2-benzisothiazolin-3-one may, generally, be the “free” 1,2-benzisothiazolin-3-one or a silver, potassium, sodium and/or lithium salt of 1,2-benzisothiazolin-3-one. A particularly preferred salt is the silver salt of 1,2-benzisothiazolin-3-one (called AgBIT below).

According to one particularly preferred embodiment of the invention, the 1,2-benzisothiazolin-3-one derivative is 1,2-benzisothiazolin-3-one.

According to one particularly preferred embodiment, the biocide composition of the invention comprises exclusively 1,2-benzisothiazolin-3-one as 1,2-benzisothiazolin-3-one derivative.

According to one preferred embodiment of the invention, the 1,2-benzisothiazolin-3-one derivative used is a mixture of two or three 1,2-benzisothiazolin-3-one derivatives. The ratio of the two or three 1,2-benzisothiazolin-3-one derivatives may in this case be varied over wide ranges and is set or selected by the skilled person in accordance with the requirement. According to one general embodiment, the biocide composition of the invention comprises BIT and M-BIT. In this case the ratio of BIT to M-BIT is approximately 5:1 to 1:1. According to a further embodiment of the invention, the biocide composition of the invention comprises BIT, M-BIT, and B-BIT, and in that case the ratio of the three BIT derivatives is approximately 10:2:1 to 2:1:1.

Suitable pyrithione or pyrithiones are in principle zinc pyrithione (called ZnPy below), sodium pyrithione (called NaPy below), silver pyrithione (called AgPy below), copper pyrithione (called CuPy below), and iron pyrithione (called FePy below). Copper pyrithione and/or iron pyrithione are used preferably in applications where discolorations have no part to play, such as in the antifouling sector, for example. In that case the biocide composition of the invention may comprise only one or else a mixture of two or more pyrithiones. According to one preferred embodiment of the invention, the biocide composition of the invention comprises one, two, or three pyrithiones, selected from NaPy, AgPy, and ZnPy.

According to one particularly preferred embodiment, the biocide composition of the invention comprises exclusively ZnPy and AgPy as pyrithione components.

An essential feature of the biocide composition of the invention is the presence of silver. The silver in the biocide composition here is in finely divided form, as elemental silver (Ag⁰) and/or in the form of its compounds with the +I oxidation stage (Ag⁻). Depending on whether the biocide composition of the invention is in liquid or solid form, and depending on the form in which the silver is present within it, the silver in the biocide composition may be distributed homogeneously, in solution or in solid mixture, for example, or in colloidal distribution, such as in colloidally disperse or nanoparticulate form, for example.

According to one embodiment of the invention, the biocide compositions of the invention comprises the silver in elemental form (Ag⁰), the particle sizes of the silver being from 0.1 to 100 μm, preferably from 0.2 to 80 μm, and more particularly from 0.25 to 60 μm. In one embodiment the silver used is nanosilver and also finely divided silver having particle sizes of 0.001 to 0.1 μm, preferably of 0.002 to 0.5 μm, and more particularly of 0.004 to 0.1 μm.

According to one preferred embodiment, the silver is present in the form of silver compounds in the biocide compositions of the invention. Silver compounds of this kind that are contemplated include organic and/or inorganic silver salts, such as, for instance, Ag-BIT, silver pyrithione (AgPy), silver chloride, silver bromide, silver nitrate, silver acetate, silver benzoate, silver citrate, silver lactate, or silver hexamethylenetetramine. In applications where any discolorations that may occur have no part to play, silver oxide is preferred more particularly. Where light-sensitive and discoloration-sensitive silver compounds are to be used as a silver component in the biocide compositions of the invention, examples being silver halides such as silver chloride or silver bromide, they are used in a specific, stabilized preparation. For example, light-sensitive and discoloration-sensitive silver compounds can be encapsulated so that they are protected from light irradiation, but at the same time the encapsulations being permeable for the microbicidally active silver ions. In this way, for example, silver chloride can be used in a stabilized preparation deposited on carrier materials, such as kaolin, talc or titanium oxide carrier material. Light-stable silver compounds can also be used directly.

Silver with low particle sizes can be employed advantageously in the biocide compositions of the invention by applying the silver to, or imbedding it in, carrier material. For this purpose it is possible for suitable carrier materials to be impregnated, for example, with colloidal silver solutions or to be mixed with finely divided silver and/or compounds of silver. It will be appreciated that it is also possible for the silver to be granulated together with the carrier materials, with addition of suitable granulating assistants. Suitable carrier materials include, in particular, builders, examples being zeolites. In addition to these it is also possible for highly porous substances, such as silicas, examples being fumed silicas, bentonites, polymeric materials, or diatomaceous earth (“kieselguhr”) to serve as carrier materials, and also ceramic materials capable of ion exchange, based for example on zirconium phosphate, or else glasses, especially bioactive or biocidal glasses. Nanosilver fixed to carrier materials is already available commercially, in the form for example of AlphaSan® (Milliken/Clariant) or else AgION™ (AgION Technologies).

According to one preferred embodiment of the invention, it may be advantageous in the biocide composition of the invention to use not only silver but also further precious activating metals such as gold or palladium, for example, which even in extremely small traces activate the antimicrobial activity of the silver.

According to one preferred embodiment of the invention, the biocide composition of the invention comprises as active microbiocidal components:
(A) silver,
(B) zinc pyrithione, and
(C) 1,2-benzisothiazolin-3-one.

According to this embodiment of the invention, use is made as component (C) of 1,2-benzisothiazolin-3-one and/or the alkali metal salt thereof (potassium, sodium and/or lithium salt thereof) or alkali metal salts thereof, or a mixture of these compounds. This preferred embodiment of the invention features the advantages already discussed above. Furthermore, this composition raises the possibility, for example, of paints and varnishes which are used in the interior sector being preserved with emissions-free biocides. Since in the preferred biocide composition the 1,2-benzisothiazolin-3-one is in the form of a salt, it can be identified as a non-emitting active ingredient and hence as a non-emitting biocide. Accordingly, advantageously, film coatings which comprise this composition of the invention do not emit any biocides, thereby making the composition of the invention particularly suitable for the preservation of paints and varnishes which are used in the interior sector.

This further effect of the above-defined preferred biocide composition plays an important part especially in respect of what is called sick building syndrome (SBS). Sick building syndrome is a building-based disorder which has its origin in evaporations from interior coatings, carpet adhesives, insulating materials, air-conditioning systems, and furniture. By using the above-specified, non-emitting biocide composition, therefore, it is possible to rule out a biocide-mediated cause for this building-based disorder.

The biocide composition of the invention comprises the silver (and/or silver compounds) preferably in defined amounts, not only absolutely but also relatively with respect to the further biocides used. In the context of the present invention, the amount of silver (Ag⁰) is always used as the basis for calculation. Where a composition of the invention comprises, for example, 100 mg of silver chloride per kg, its silver content is 73.53 mg/kg in % by weight, expressed as 0.007% by weight.

The amount of the three active biocidal components and their ratio to one another in the biocide composition of the invention may vary over wide ranges, depending on intended use, and is specified typically by the skilled person in the field of biocides. The ratios given below provide the skilled person with formulating information:

It is advantageous if in the biocide composition of the invention the 1,2-benzisothiazolin-3-one derivative or 1,2-benzisothiazolin-3-one derivatives and the silver are present in a weight ratio of (100:1) to (1:20), preferably (50:1) to (1:5), more particularly of (20:1) to (5:1).

It is advantageous if in the biocide composition of the invention the pyrithione and/or the pyrithiones and the silver are present in a weight ratio of (100:1) to (1:20), preferably (50:1) to (1:5), more particularly of (10:1) to (3:1).

It is advantageous if the biocide composition of the invention pyrithione and the 1,2-benzisothiazolin-3-one derivative or the 1,2-benzisothiazolin-3-one derivatives are present in a weight ratio of (100:1) to (1:100), preferably (50:1) to (1:50), more particularly of (1:1) to (1:20).

The biocide composition of the invention may be present in and employed in a wide variety of preparations, such as in solid form, as a mixture of the components it comprises.

According to one preferred embodiment, the biocide composition is in the form of a concentrate having the below-specified concentrations, which is added to the products that are to be preserved.

It is advantageous if the biocide composition of the invention comprises silver (Ag⁰ or Ag⁺) in an amount from 0.01% to 10% by weight, preferably 0.05% to 4% by weight, more preferably 0.1% to 2% by weight.

The amount of pyrithione(s) in the biocide composition of the invention is preferably 0.01% to 30% by weight, preferably 0.25% to 20% by weight, more preferably 0.5% to 15% by weight.

The amount of 1,2-benzisothiazolon-3-one derivative(s) in the biocide composition of the invention is preferably 1% to 50% by weight, preferably 2.5% to 30% by weight, more preferably 5% to 25% by weight.

The biocide composition of the invention in the form of the concentrate may further comprise other customary constituents and/or auxiliaries which are known as adjuvants to the skilled person in the field of biocides. These are, for example, solvents such as, more particularly, water, UV stabilizers, carrier materials, thickeners, defoamers, pH modifiers, fragrances, dispersing assistants, and colorants or discoloration preventatives, complexing agents, and stabilizers.

A composition comprising silver, one or more pyrithiones and one or more 1,2-benzisothiazolin-3-one derivatives in the weight ratios specified is referred to generally as a “biocide composition of the invention”. In addition to the at least three stated active biocidal components in the stated weight ratios, a “biocide composition of the invention” may further comprise one or more additional constituents, more particularly biocides. This or these further constituent or constituents may have a microbicidal activity, or may not have any microbicidal activity, and may therefore be, for instance, a solvent, UV stabilizer, dispersion medium or suspension medium.

In a further embodiment of the invention, the biocide composition of the invention consists substantially of silver, one or more pyrithiones and one or more 1,2-benzisothiazolin-3-one derivatives as active biocidal components, which means that apart from the three active biocidal components there may well be one or more other biocides present, but that they are present in an amount in which there is no contribution to the overall effect of the resultant mixture from the respective biocide that is different from the three stated biocidal components. If, therefore, the biocidal activity of a biocide composition of the invention which as well as silver, pyrithione(s), and benzisothiazolinone(s), as an essential constituent, also comprises one or more further biocides in subordinate or minor concentration, shows no change as compared with the use of the biocidal composition of the invention, it is referred to in connection with the present invention as being “substantially consisting”. There may be one or more further constituents without a biocidal activity, such as solvents.

In one preferred embodiment, the biocidal composition of the invention may consist of the three active microbicidal components (A), (B), and (C) as sole biocidal actives, thus having an actives content of 100% in the stated weight ratios. In such a case it is merely possible for one or more further constituents to be present without a biocidal activity, such as solvents.

In one advantageous embodiment, the biocide composition of the invention is in the form of a liquid preparation, such as a solution, suspension or dispersion in a liquid medium, for example. It will be appreciated that the biocide composition of the invention can also be mixed directly in the product that is to be preserved.

If, in one advantageous embodiment, the biocide composition of the invention is employed as a liquid preparation, the liquid medium used may be a polar and/or apolar medium.

Preferred polar liquid media are water, aliphatic alcohols having 1 to 4 carbon atoms, such as ethanol and isopropanol, a glycol, such as ethylene glycol, diethylene glycol, 1,2-propylene glycol, dipropylene glycol, and tripropylene glycol, a glycol ether, such as butyl glycol and butyl diglycol, a glycol ester, such as butyl diglycol acetate or 2,2,4-trimethylpentanediol monoisobutyrate, a polyethylene glycol, a polypropylene glycol, N,N-dimethylformamide, or a mixture of 2 or more such media.

The polar liquid medium is, in particular, exclusively water which means that water is present as sole solvent. According to this particularly preferred embodiment, the biocide composition of the invention is free from VOCs (volatile organic compounds).

A further possibility is to adapt the biocide composition of the invention to specific objectives through the addition of further biocidal actives—for example, to adapt it for increased or specific biocidal activity, or for enhanced compatibility with the substances to be protected from the microorganisms.

Specific examples of such further biocidal actives are given below:

Benzyl alcohol, 2,4-dichlorobenzyl alcohol, 2-phenoxyethanol, 2-phenoxyethanol hemiformal, phenylethyl alcohol, 5-bromo-5-nitro-1,3-dioxane, formaldehyde and formaldehyde-releasing compounds, such as tetramethylol-acetylenediurea, N,N′-dimethylolurea, N-methylolurea, dimethyloldimethylhydantoin, N-methylolchloroacetamide, reaction products of allantoin, glycol formals, such as ethylene glycol formal, butyl diglycol formal, and benzyl formal, glyoxal, glutaraldehyde, sorbic acid, benzoic acid, salicylic acid, p-hydroxybenzoic esters, chloroacetamide, N-methylolchloroacetamide, phenols, such as p-chloro-m-cresol and o-phenylphenol, 4,4-dimethyl-1,3-oxazolidine, 1,3,5-hexa-hydrotriazine derivatives, quaternary ammonium compounds, such as N-alkyl-N,N-dimethylbenzylammonium chloride and di-n-decyldimethylammonium chloride, cetylpyridinium chloride, diguanidine, polybiguanide, chlorhexidine, 1,2-di-bromo-2,5-dicyanobutane, 3,5-dichloro-4-hydroxybenzaldehyde, ethylene glycol hemiformal, tetra(hydroxymethyl)phosphonium salts, dichlorophene, 2,2-dibromo-3-nitrilopropionamide, 3-iodo-2-propynyl-N-butylcarbamate, methyl N-benzimidazol-2-ylcarbamate, N,N-dimethyl-2,2′-dithiobenzamide, 2-thio-cyanomethylthiobenzothiazole, C-formals, such as 2-hydroxy-methyl-2-nitro-1,3-propanediol, 2-bromo-2-nitropropane-1,3-diol, methylene bisthiocyanate, trichlosan, 5-chloro-2-methyl-2H-isothiazolin-3-one, 2-methyl-2H-isothiazolin-3-one, 2-n-octyl-2H-isothiazolin-3-one, and 4,5-dichloro-2-n-octyl-2H-isothiazolin-3-one.

Preferred such further biocidal actives are 5-chloro-2-methyl-2H-isothiazolin-3-one, 2-methyl-2H-isothiazolin-3-one, 2-n-octyl-2H-isothiazolin-3-one, 4,5-dichloro-2-n-octyl-2H-isothiazolin-3-one, quaternary ammonium compounds, such as N-alkyl-N,N-dimethylbenzylammonium chloride and di-n-decyldimethylammonium chloride, cetylpyridinium chloride, and diguanidine(polyhexamethylenebiguanide), 1,2-dibromo-2,4-di-cyanobutane, 2,2-dibromo-3-nitrilopropionamide, and 2-bromo-2-nitropropane-1,3-diol.

The actives indicated above are used generally, based on the three active components of the biocide composition of the invention, in a ratio of 1:20 to 20:1, preferably in a ratio of 1:10 to 10:1, more preferably in a ratio of 3:1 to 1:2. As further biocidal active it is possible for one individual active or for two, three, four, five or more of the abovementioned actives to be present in the biocide composition.

The biocide composition of the invention can be used for preservation in a very wide variety of fields.

According to a first embodiment it is suitable, for example, for use in coating materials, such as, for example, paints, varnishes, stains, and renders, in emulsions, latices, polymer dispersions, lignosulfonates, chalk slurries, mineral slurries, ceramic masses, adhesives, sealants, products containing casein, products containing starch, bitumen emulsions, surfactant solutions, motor fuels, cleaning products, pigment pastes and pigment dispersions, inks, lithographic fluids, thickeners, cosmetic products, toiletries, water circuits, liquids associated with paper processing, liquids associated with leather making, liquids associated with textile production, drilling and cutting oils, hydraulic fluids, and cooling lubricants, against infestation with, for example, bacteria, filamentous fungi, yeasts, and algae.

The biocide composition of the invention is used preferably to counter infestation by microorganisms in coating materials, such as, for example, paints, varnishes, stains, and renders, in emulsions, latices, polymer dispersions, adhesives, cleaning products, mineral slurries, ceramic masses, pigment pastes and pigment dispersions, and also sealants. Particularly preferred fields of use are coating materials such as, for example, paints, varnishes, stains, and renders, and also emulsions, latices, polymer dispersions, and adhesives.

In terms of practical application, the biocide composition can be incorporated, either as a finished mixture or by separate addition of biocides and of the remaining components of the composition, into the substance or product that is to be preserved.

The amount of the three biocidal active components in preservative application (the use concentration) may be varied over wide ranges, according to the purpose of use, and is typically specified by the skilled person in the field of biocides. The concentration ranges indicated below provide the skilled person with an indication of the concentrations to be used:

In the product to be preserved by the biocide composition of the invention against infestation by microorganisms, the silver is present generally in an amount of 0.1 ppm to 100 ppm, preferably in an amount of 0.1 ppm to 50 ppm, more preferably in an amount of 0.1 ppm to 25 ppm, very preferably in an amount of 0.1 ppm to 10 ppm.

The amount of the pyrithione(s) in the substance/-product to be preserved is generally 1 to 1000 ppm, preferably 20 to 200 ppm, more preferably 10 to 100 ppm.

The amount of the 1,2-benzisothiazolinone(s) in the product to be preserved is generally 10 to 2000 ppm, preferably 50 to 500 ppm, more preferably 75 to 250 ppm.

According to one further preferred embodiment of the invention, the biocide compositions of the invention and the products furnished with them additionally comprise zinc compounds and/or zinc salts and/or zinc ions, in order to minimize further the incidence of any discolorations originating from the pyrithione. The zinc compound in this case is used generally, based on the pyrithione component, in a weight ratio of 10 000:1 to 1:10 000, preferably in a ratio of 100:1 to 1:200, more preferably in a ratio of 1:2.

The examples which follow serve for further illustration of the present invention.

### EXAMPLE 1

### Investigation of the Synergistic Activity of the Three Active Biocidal Components on Different Organisms

A test was made of the synergism of a combination of BIT, zinc pyrithione or sodium pyrithione, and silver. The test organisms used were the yeasts Candida albicans (DSM 1386) and Candida lipolytica (DSM 3286). For the test, mixtures with different compositions of BIT, zinc pyrithione or sodium pyrithione, and silver were prepared and were tested for their activity on Candida albicans and Candida lipolytica.

The individual actives or actives mixtures were mixed in serial concentration series with nutrient broth (Sabouraud maltose broth) and inoculated with the respective test organisms. The cell density in the overall batch was in each case 10⁶ microbes per ml.

The incubation time was 72 hours at 25° C. on a shaker at 120 rpm. This was followed by inspection for growth of Candida albicans and Candida lipolytica.

This method was used to determine the minimum inhibitory concentrations (MICS) of the combination Ag+BIT and ZnPy or NaPy, with Ag and BIT always being present in a 1:20 ratio. The MIC is the concentration at which there is no longer any hazing of the nutrient solution.

The synergism which occurred was represented numerically by calculation of the synergy index (SI). The calculation was made according to the common method of F. C. Kull et al., Applied Microbiology, vol. 9 (1961), p. 538. The SI variant was given by the following formula:

Synergy index SI=Qₐ/Q_{A}+Q_{b}/Q_{B}

When this formula is applied to the BIT+pyrithione+silver biocide system tested here, the variables in the formula have the following definition:
Qₐ=Concentration of Ag+BIT in the Ag+BIT and ZnPy mixture
Q_{A}=Concentration of Ag+BIT as sole biocide
Q_{b}=Concentration of ZnPy in the Ag+BIT and ZnPy mixture
Q_{B}=Concentration of ZnPy as sole biocide

If the synergy index has a value of more than 1, this means that antagonism is present. If the synergy index adopts a value of 1, this means that the two biocides have an additive effect. If the synergy index adopts a value of below 1, this means that the biocides exhibit synergism.

TABLE 1
Calculation of the synergy index of silver + BIT + ZnPy with
respect to Candida albicans, with an incubation time of
72 hours at 25° C.

| MIC Qa | MIC Qb | | | | |
|---|---|---|---|---|---|
| (Ag + BIT; 1:20) | (ZnPy) | Total | Ag + BIT | ZnPy | |
| [ppm] | [ppm] | [ppm] | Qa/QA | Qb/QB | SI |
| 0 | 7.5*² | 7.5 | 0.0 | 1.0 | 1.00 |
| 9.45 | 5 | 14.45 | 0.2 | 0.67 | 0.87 |
| 9.45 | 0.5 | 9.95 | 0.2 | 0.07 | 0.27 |
| 23.68 | 0.25 | 23.93 | 0.5 | 0.03 | 0.53 |
| 47.25*¹ | 0 | 47.25 | 1.0 | 0.0 | 1.00 |

*¹Q_{A}
*²Q_{B}
Qₐ = Concentration of Ag + BIT in the Ag + BIT and ZnPy mixture
Q_{A} = Concentration of Ag + BIT as sole biocide
Q_{b} = Concentration of ZnPy in the Ag + BIT and ZnPy mixture
Q_{B} = Concentration of ZnPy as sole biocide

From table 1 it is evident that the optimum synergism, i.e., the lowest synergy index (0.27) for a biocide composition comprising silver, BIT, and ZnPy, is located with a ratio of 0.45 ppm Ag+9 ppm BIT+0.5 ppm ZnPy.

TABLE 2
Calculation of the synergy index of silver + BIT + NaPy with
respect to Candida lipolytica, with an incubation time of
72 hours at 25° C.

| MIC Qa | MIC Qb | | | | |
|---|---|---|---|---|---|
| (Ag + BIT; 1:20) | (NaPy) | Total | Ag + BIT | NaPy | |
| [ppm] | [ppm] | [ppm] | Qa/QA | Qb/QB | SI |
| 0 | 30*² | 30 | 0.0 | 1.0 | 1.00 |
| 4.73 | 25 | 29.73 | 0.07 | 0.83 | 0.90 |
| 4.73 | 10 | 14.73 | 0.07 | 0.33 | 0.40 |
| 9.45 | 7.5 | 16.95 | 0.13 | 0.25 | 0.38 |
| 23.68 | 2.5 | 26.18 | 0.33 | 0.08 | 0.41 |
| 37.80 | 1 | 38.80 | 0.53 | 0.03 | 0.56 |
| 70.88*¹ | 0 | 70.88 | 1.0 | 0.0 | 1.00 |

*¹Q_{A}
*²Q_{B}
Qₐ = Concentration of Ag + BIT in the Ag + BIT and NaPy mixture
Q_{A} = Concentration of Ag + BIT as sole biocide
Q_{b} = Concentration of NaPy in the Ag + BIT and NaPy mixture
Q_{B} = Concentration of NaPy as sole biocide

From table 2 it is evident that the optimum synergism, i.e., the lowest synergy index (0.38) for a biocide composition comprising silver, BIT, and NaPy, is located with a ratio of 0.45 ppm Ag+9 ppm BIT+7.5 ppm NaPy.

TABLE 3
Calculation of the synergy index of silver + BIT + ZnPy with
respect to Candida lipolytica, with an incubation time of
72 hours at 25° C.

| MIC Qa | MIC Qb | | | | |
|---|---|---|---|---|---|
| (Ag + BIT; 1:20) | (ZnPy) | Total | Ag + BIT | ZnPy | |
| [ppm] | [ppm] | [ppm] | Qa/QA | Qb/QB | SI |
| 0 | 7.5*² | 7.5 | 0.0 | 1.0 | 1.00 |
| 9.45 | 3 | 12.45 | 0.13 | 0.4 | 0.53 |
| 23.68 | 2.5 | 26.18 | 0.33 | 0.33 | 0.66 |
| 28.35 | 1 | 29.35 | 0.4 | 0.13 | 0.53 |
| 46.61 | 0.25 | 46.86 | 0.66 | 0.03 | 0.69 |
| 70.88*¹ | 0 | 70.88 | 1.0 | 0.0 | 1.00 |

*¹Q_{A}
*²Q_{B}
Qₐ = Concentration of Ag + BIT in the Ag + BIT and ZnPy mixture
Q_{A} = Concentration of Ag + BIT as sole biocide
Q_{b} = Concentration of ZnPy in the Ag + BIT and ZnPy mixture
Q_{B} = Concentration of ZnPy as sole biocide

From table 3 it is evident that the optimum synergism, i.e., the lowest synergy index (0.53) for a biocide composition comprising silver, BIT, and ZnPy, is located with a ratio of 0.45 ppm Ag+9 ppm BIT+3 ppm ZnPy.

1. A biocide composition comprising as active microbicidal components
(A) silver,
(B) one or more pyrithiones, and
(C) one or more 1,2-benzisothiazolin-3-one derivatives.

2. The biocide composition as claimed in claim 1, characterized in that the silver is present in the form of organic or inorganic silver salt.

3. The biocide composition as claimed in claim 1, characterized in that the silver is present on a carrier material, such as kaolin, talc or titanium oxide.

4. The biocide composition as claimed in claim 1, characterized in that the 1,2-benzisothiazolin-3-one derivative is 1,2-benzisothiazolin-3-one, N-methyl-1,2-benzisothiazolin-3-one, N-butyl-1,2-benzisothiazolin-3-one or a mixture of two or three of these compounds.

5. The biocide composition as claimed in claim 1, characterized in that the pyrithione is zinc, sodium, silver, copper or iron pyrithione or a mixture of at least two of these compounds.

6. The biocide composition as claimed in claim 1, comprising as active microbicidal components
(A) silver,
(B) zinc pyrithione, and
(C) 1,2-benzisothiazolin-3-one.

7. The biocide composition as claimed in claim 1, characterized in that it comprises the pyrithione in an amount of 0.01% to 30% by weight, based on the overall biocide composition.

8. The biocide composition as claimed in claim 1, characterized in that it comprises the silver in an amount of 0.01% to 10% by weight, based on the overall biocide composition.

9. The biocide composition as claimed in claim 1, characterized in that it comprises the 1,2-benzisothiazolin-3-one derivative in an amount of 1.0% to 50% by weight, based on the overall biocide composition.

10. The biocide composition as claimed in claim 1, characterized in that it is in the form of a liquid preparation.

11. The use of the biocide composition as claimed in claim 1 for in-can preservation.

12. The use of the biocide composition as claimed in claim 1 for the in-can preservation of coating materials, such as paints, varnishes, and renders, of polymer dispersions, emulsions, latices, and adhesives.

13. A preserved product comprising a biocide composition as claimed in claim 1.

14. The preserved product as claimed in claim 13, selected from the group consisting of paints, varnishes, stains, renders, latices, polymer dispersions, adhesives, cleaning products, lignosulfonates, chalk slurries, mineral slurries, ceramic masses, adhesives, sealants, products containing casein, products containing starch, bitumen emulsions, surfactant solutions, motor fuels, cleaning products, pigment pastes and pigment dispersions, inks, lithographic fluids, thickeners, cosmetic products, toiletries, water circuits, liquids associated with paper processing, liquids associated with leather making, liquids associated with textile production, drilling and cutting oils, hydraulic fluids, and cooling lubricants.
